(19) United States
(12) Patent Application Publication
(10) Pub. No.: US 2023/0129802 A1
(43) Pub. Date: Apr. 27, 2023

(54) REMOVAL OF SILICA AND TOTAL ORGANIC CARBON FROM WASTEWATER

(71) Applicant: UTI Limited Partnership, Calgary (CA)

(72) Inventors: Afif HETHNAWI, Calgary (CA); Nashaat N. NASSAR, Calgary (CA)

(21) Appl. No.: 17/908,756

(22) PCT Filed: Feb. 26, 2021
(86) PCT No.: PCT/CA2021/050255

§ 371 Date: Sep. 1, 2022

Related U.S. Application Data
(60) Provisional application No. 62/986,306, filed on Mar. 6, 2020.

(51) Int. Cl. C02F 1/28; B01J 20/24; B01J 20/08; B01J 20/32; B01J 20/30; B01J 20/28; E21B 43/24; E21B 43/34

(52) U.S. Cl. CPC C02F 1/288; B01J 20/24; B01J 20/08; B01J 20/3208; B01J 20/3071; B01J 20/3221; B01J 20/3236; B01J 20/28016; E21B 43/2406; E21B 43/35; C02F 2101/32

(57) ABSTRACT

A filter medium for removal of contaminants from wastewater. The filter medium includes a walnut shell particle having a metal hydro(oxide) nanoparticle bonded to the surface of the nut shell particle. The filter medium is particularly useful for treating produced water and wastewater generated in steam-assisted gravity drainage (SAGD) in recovery of hydrocarbons from oil sands to remove total organic carbon and silica. Processes for preparing the filter medium and for treating wastewater using the filter medium are also provided.

### CROSS-REFERENCE TO RELATED APPLICATIONS

This application claims priority to U.S. Provisional Patent Application Ser. No. 62/986,306, filed on Mar. 6, 2020, which is incorporated herein by reference in its entirety.

### FIELD OF THE INVENTION

The invention relates to treatment of wastewater and more particularly to wastewater treatment associated with recovery of hydrocarbons, wherein the wastewater contains high levels of total organic carbon and silica/silicates and is treated using filtration media.

### BACKGROUND

Steam assisted gravity drainage (SAGD) is considered an important process for recovery of hydrocarbons from oil sands in Alberta with about 80% of oil sands deposits being appropriate for use of this process.¹⁻⁴ The process requires drilling of two horizontal wells.¹ The upper well is utilized to inject the heated steam inside the oil well deposit. This steam builds up heat, which is transferred to the adjacent area, reducing the viscosity of the bitumen and subsequently mobilizing it.⁵ Thus, the mobilized bitumen, along with the condensate steam, are drained downward by gravity to the second horizontal well, which it pumps to the surface. At the surface, the bitumen is separated via subsequent cooling units followed by a phase containing oil and water generating significant volumes of wastewater as which is also known as “produced water.”^{1,5} The produced water derived from oil recovery processes (which is also known as “oily wastewater”) has high concentrations (from 1000 to 10,000 mg/L) of brine, silica and silicates, alkaline compounds, and total dissolved solids.⁶⁻⁸ From an environmental point of view, the contaminants of produced water can affect surface water quality and the ecosystem.⁶⁻⁸ The influent steam for the SAGD process, which must meet certain constraints with respect to water quality, is produced by a system known as a once-through steam generator (OTSG).⁹ This system generates steam with feed water containing up to 80% silica/silicates for thermal recovery applications.¹⁰ In OTSG, a single pass of water is run through the generator coil without a separator drum, generating 80% quality steam with a water to steam ratio of 1:4.¹⁰ The effluent of this process is typically characterized by low salinity, and high concentrations of silica/silicates, hardness, and total organic carbon (TOC). OTSG is specifically developed to use a heat recovery steam generator for thermal recovery applications.¹⁰

There continues to be a need for improving removal of contaminants from wastewater prior to its use in steam generation and other applications.

### SUMMARY

According to one embodiment, there is provides a filter medium for removal of contaminants from wastewater. The filter medium includes a nut shell particle having a metal hydro(oxide) nanoparticle bonded to a surface thereof. The metal may be a transition metal or a Group IIIA metal. In some embodiments, the metal is iron or aluminum or a mixture thereof. The nut shell may be a walnut shell or a pecan shell. The nanoparticle may be bonded to the surface of the nut shell particle via an oxygen bridge.

According to another embodiment, there is provided a process for preparing a filter medium for removal of contaminants from wastewater. The process includes the steps of: treating a nut shell filter medium with an aqueous acid solution and washing the nut shell filter medium; mixing the nut shell filter medium with a source of metal ions, to generate a mixture including an aqueous metal complex; and heating the mixture to promote a thermal hydrolysis reaction which generates a metal hydro(oxide) nanoparticle bonded to a surface of the nut shell medium. The metal may be a transition metal or a Group IIIA metal. The metal may be iron or aluminum or a mixture thereof. The nut shell may be a walnut shell or a pecan shell. The nanoparticle may be bonded to the surface of the nut shell particle via an oxygen bridge.

According to another embodiment, there is provided a process for treating wastewater to remove contaminants, the process includes the steps of contacting the wastewater with a nut shell particle as described herein, such that the contaminants adhere to the metal hydro(oxide) nanoparticle and recovering water having at least some of the contaminants removed therefrom. The step of contacting the wastewater with the nut-shell particle may be performed in a batch mode. The contaminants may include total organic carbon (TOC), silica or silicates.

In accordance with another embodiment, the process for treating wastewater to remove contaminants is used in treatment of wastewater in a steam-assisted gravity drainage (SAGD) operation.

### BRIEF DESCRIPTION OF THE DRAWINGS

Various objects, features and advantages of the invention will be apparent from the following description of particular embodiments of the invention, supported by the accompanying drawings. The drawings are not necessarily to scale. Emphasis is placed upon illustrating the principles of various embodiments of the invention.

FIG. 1 is a schematic diagram of a conventional process for treatment of SAGD wastewater which includes warm lime softening (WLS), walnut-shell filtration (WSF) and weak acid cation exchange (WAC).

FIG. 2 illustrates a fixed bed column arrangement which was used to remove silica and TOC through the walnut shell particles before and after surface modification with iron hydro(oxide) nanoparticles.

FIG. 3(a) is an SEM image of untreated walnut shell medium (WS-VR).

FIG. 3(b) is an SEM image of acid treated walnut shell medium (WS-AT).

FIG. 3(c) is an SEM image of acid treated walnut shell medium with anchored iron hydro(oxide) nanoparticles (WS-NPs).

FIG. 4 is a plot of XRD spectra for walnut shell particles before (WS-VR) and after acid treatment (WS-AT) and after anchoring of iron hydro(oxide) nanoparticles (WS-NPs).

FIG. 5 is a plot of FTIR spectra for walnut shell particles before (WS-VR) and after acid treatment (WS-AT) and after anchoring of iron hydro(oxide) nanoparticles (WS-NPs).

FIG. 6 is a scheme indicating treatment of walnut shell media (WS-VR) with acid to enhance exposure of reactive carboxylate groups (WS-AT) followed by anchoring of iron hydro(oxide) nanoparticles (WS-NPs).

FIG. 7 Iron hydrolysis products. Solid lines indicate known reaction sequences and the dashed lines indicate predicted reaction sequences.

FIG. 8 Anchorage of Fe(OH)₃ nanoparticles to the WS surface and adsorption of silica and TOC onto the functionalized surface.

FIG. 9(a) is a plot of iron weight percentages for WS-PNs obtained over a range of temperatures and hydrolysis reaction periods of 4, 8, and 12 hours with 1 M FeCl₃.6H2O.

FIG. 9(b) is a plot of iron weight percentages for WS-PNs obtained over a range of temperatures and hydrolysis reaction periods of 4, 8, and 12 hours with 2 M FeCl₃.6H2O.

FIG. 10 is a bar chart indicating percentages of removal of TOC by untreated walnut shell media (WS-VR), acid treated walnut shell media (WS-AT) and the acid-treated walnut shell media with anchored iron hydro(oxide) nanoparticles (WS-NPs). Photographs of the wastewater samples following the treatment are shown with TOC and silica concentration data indicated.

FIG. 11. Adsorption isotherms of silica and TOC on WS-NPs together with the Sips model fitting (dashed lines) at pH 8.9 and temperature 298 K.

FIG. 12 includes a series of FTIR spectra of a SAGD wastewater (influent) sample, the same sample following filtration with anchored iron hydro(oxide) nanoparticles (WS-NPs) and the same sample following treatment with WS-NPs which are considered to be spent (WS-NPs-spent) and no longer capable of providing adequate filtration.

FIG. 13 Model of silica species and their polymerization path into amorphous structure under aqueous conditions. The center of each tetrahedron is Si and the terminal atoms are oxygen.

FIG. 14 Breakthrough curves for the simultaneous removal of (a)TOC and (b) silica inside the fixed bed columns of WS-VR and WS-NPs at constant bed depth 8 cm, initial concentrations of TOC (450 mg/L) and silica (155 mg/L), and flow rates of 10 mL/min. The inset graphs represent the obtained pressure drop profiles during the column operations

FIG. 15 Breakthrough curves for the simultaneous removal of (a) TOC and (b) silica inside the fixed bed columns of WS-NPs at constant bed depth 10.2 cm, initial concentrations of TOC (450 mg/L) and silica (155 mg/L), and various flow rates of 10, 20, and 30 mL/min. The inset graphs represent the obtained pressure drop profiles during the column operations.

FIG. 16 Breakthrough curves for the simultaneous removal of (a) TOC and (b) silica inside the fixed bed columns of WS-NPs at constant bed depth (10.2 cm), and flow rate (10 ml/min), and various feed concentrations of TOC (150-450 mg/L) and silica (51.6-155 mg/L). The inset graphs represent the obtained pressure drop profiles during the column operations.

FIG. 17 Breakthrough curves for the simultaneous removal of (a) TOC and (b) silica inside the fixed bed columns of WS-NPs at constant flow rate (10 mL/min), feed concentration of silica (155 mg/L) and TOC (450 mg/L), and various bed heights (10.2,15.2, and 25.4 cm). The inset graphs represent the obtained pressure drop profiles during the column operations.

FIG. 18 Breakthrough curves of (a) TOC and (b) silica through recycling the spent WS-NPs during 3 cycles along with backwashing profiles of (c) TOC and (d) silica obtained by applying the backwashing method. The column experiment for each cycle are Q=10 mL/min, Z=10 cm, C_{o,TOC}=145 mg/L, C_{o,Silica}=155 mg/L, and pH=9. The graphs show the obtained pressure drop profiles during the column operations.

FIG. 19 Breakthrough curves of (a) TOC and (b) silica through recycling the spent WS-NPs during 3 cycles obtained by stirring method. The column experiment for each cycle: Q=10 mL/min, Z=4 in, C_{o,TOC}=145 mg/L, C_{o,Silica}=155 mg/L, and pH=9. The graphs show the obtained pressure drop profiles during the column operations.

### DETAILED DESCRIPTION

### Introduction and Rationale

Table 1 includes typical SAGD produced water concentrations (mg/L), as well as the desirable feed constraints for OTSG in form of total dissolved solids (TDS), total organic carbon (TOC), silica/silicates, and hardness (as CaCO₃).¹¹⁻¹³

TABLE 1
Typical compositions of total dissolved solids
(TDS), total organic carbon (TOC), silica (SiO₂),
and hardness for the SAGD process and OTSG.

| | | Concentration | |
|---|---|---|---|
| | Effluent from | Constraints for | |
| Contaminants | SAGD Process (mg/L) | OTSG (mg/L) | References |
| TDS | 4000-6500 | 700 | 9, 11 |
| TOC | 300-450 | <50 | 11, 14 |
| Silica | 150-400 | <30 | 11, 12, 13 |
| Hardness | 150-300 | <0.5 | 11, 12, 13 |
| (as CaCO₃) | | | |

Total organic carbon (TOC) is one of the most important sum parameters in the assessment of the organic pollution of water. Since it includes all carbon compounds as one mass, it is exactly defined and an absolute quantity. Therefore, it may be determined directly.

As used herein, the term “silica” is used to refer to any mixture of silica (SiO₂) and silicate-based mineral compounds or ions which may be present in wastewater, including produced water and/or wastewater originating from SAGD operations.

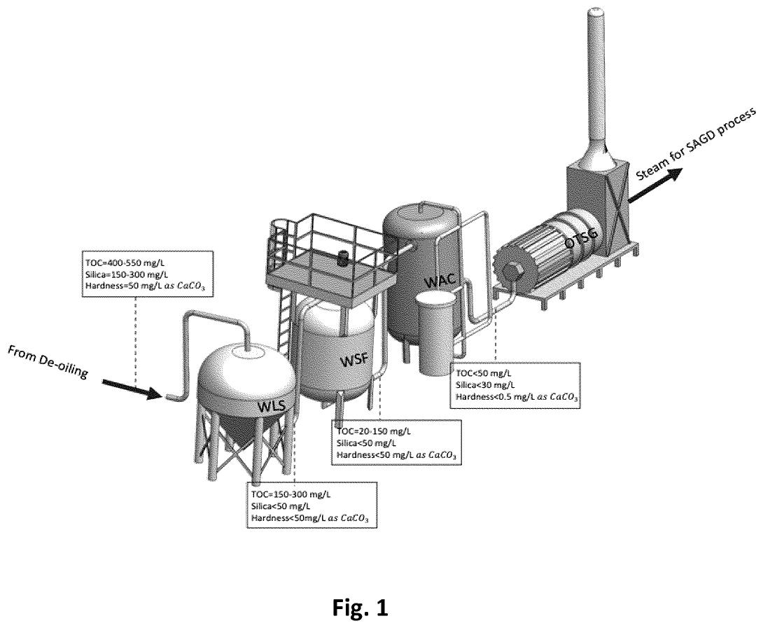

It is undesirable to exceed the tabulated “threshold requirement concentrations” in reusing as boiler feed water in an oilfield steam generator. Therefore, effective treatment of the boiler feed water through selective water treatment technologies is required. The generated SAGD-produced water must meet strict requirements as an input for the boiler employed for steam generation. ^{5,11,12,14,15} Otherwise, the boiler drum and tubes can be damaged or corroded. Therefore, oil sands companies in Canada are seeking new technologies or modifying their currently implemented technologies. Efforts to develop improvements have costs representing a considerable proportion of the total cost in oil recovery. Traditionally, a sequence of water treatment technologies has been employed which depend on the chemical and physical characteristics of the produced water in conjunction with a conventional steam reboiler.^{11,16} A conventional SAGD wastewater treatment scheme is shown in FIG. 1.

These technologies can be classified as pre-treatment (de-oiling) and primary (conventional treatment) stages. In the de-oiling unit, a series of gravity and flotation vessels (API and CPI vessels) are used, as well as skim tanks and induced static flotation (ISF) to remove the heavy bitumen from the produced water.^{11,17} Then the de-oiled water is mixed with fresh water to generate a feed for warm lime softening.^{11,17} In warm lime softening, the hardness (calcium and magnesium ions) as well as the alkalinity are neutralized by adding chemicals such as lime (Ca(OH)₂), soda ash (Na₂CO₃), and caustic soda (NaOH).^{11,17} As a result, the concentration levels of silica, TOC, and TDS are reduced to ranges of 50-150 mg/L, 300-500 mg/L, and 1500-2000 mg/L, respectively.

Interestingly, the level of the silica (90%) reduced by warm lime softening is due to adsorption of the silica on the surface of precipitated magnesium ions.¹¹ Subsequently, the free oil content is further lowered to below 20 mg/L using a walnut shell filter^{11,17} in the presence of a high concentration of divalent ions (Ca⁺² and Mg⁺²). These divalent ions are then treated by applying weak acid cation exchange process, as a last step. During weak acid cation exchange, resins with carboxylic acid derivatives are added for de-alkalization of water.¹⁷ Thus, the total alkalinity (carbonates and non-carbonates) is removed. This conventionally treated water has negligible amounts of divalent ions, and also very low concentration of silica (<50 mg/L). The treated water, which can be used as a feed for the boiler, is known as boiler feed water. As effluent, boiler feed water is distributed into two streams. One stream is recycled back to the warm lime softening unit and the second stream is fed into the OTSG process. However, the process steps described above for the conventional SAGD design does not remove or reduce the high concentrations of both silica and TOC. TDS and TOC concentration levels are also increased with introduction of resins prior to the weak acid cation exchange part of the conventional process. The high levels of both of these contaminants severely interferes with subsequent recycling of the produced water because more low-quality water is blown down in OTSG. In fact, accumulation of silica and TOC results in damage and corrosion of OTSG drums and tubes, which leads to a requirement for more evaporators or larger volume evaporators. Therefore, effective emerging technologies are being investigated to address the high levels of silica and TOC.¹⁷

Technologies for modifying/replacing the current OTSG plant will be expected to reduce the capital and operational costs with fewer smaller evaporators. Therefore, an effective new method should be developed as secondary or tertiary treatment technology to improve water quality for steam generation.

Many potential technologies (e.g., chemical, physical, biological, and membrane filtration) have been considered for treatment of wastewater generated during extraction of hydrocarbons.^{8,18-21} Biological treatment by microbial agents, for instance, can be considered as an attractive solution to remove organic pollutants. However, microbial agent growth is highly sensitive to salinity.^{15,22} Cold weather also can slow down the activity of the micro-organisms that subsequently lead to a low treatment efficiency. Biological treatment has its own limitations and cannot be effectively used for oil field applications to treat or degrade numerous complex organic compounds.¹⁵ Therefore, biological treatment processes were deemed unreliable for the treatment of SAGD water.

Membrane filtration is increasingly investigated used as an alternative option which has attracted the attention of many researchers over the past 10 years. Two main parameters determine the membrane performance: selectivity and flux.^{8,18-21} In membrane filtration, selectivity provides the ability to keep the solute on the influent side, while the rate at which the solute material moves across the membrane influenced by pressure or concentration gradients (driving force for mass transfer) can be represented as flux. In membrane filtration, depositing TOC on the feed side causes membrane fouling which reduces the effectiveness of the membrane. Increasing the TOC or silica contents in the feed requires a thicker membrane but it can increase the resistance. Thus, flux is reduced, and less efficiency can be obtained, which considered as a strong downside for supplying fresh water for a SAGD process. Therefore, biological and filtration processes are inappropriate due to technical challenges as well as operational and capital costs.

Recently, investigators have focused their efforts on modifying or replacing the existing technology to achieve improvements in industrial compliance. In the walnut shell filtration part of the process, deep bed-filter media known as walnut shell filters are conventionally used due to their oil and solid filtration performance combined with ease of backwashing. Walnut shell filter media have several unique characteristics which do not exist in mineral and polymer-based media. The material is hard, light, chemically inert, nontoxic, and biodegradable).²³ These characteristics, in addition to having a high affinity for uptake of mineral oils, have led to the use of walnut shell filter media for separating crude oil from water (e.g., reduction of TOC concentration from SAGD wastewater). Walnut shell particles can be prepared with a fairly uniform size, which is considered an important feature to attain effective rapid filtration. This uniformity allows the filter to operate at a high hydraulic rate that contributes to lowering of the head loss and provides a void space greater than the filtered particles. Straining tends to be the limiting mechanism for removing the pollutant particles. Therefore, the particles can be removed from the entire depth of the filter by depth filtration, which gives the filter high capacity for solid retention without rapid clogging. For particles to be removed via depth filtration as wastewater passes through the filter bed, they should adhere to the filter grains after destabilization via a coagulation step. Without a coagulation step, a repulsion force will prevent contact the particle from contacting the media. Generally, an interaction between the walnut shell particles and the contaminants occurs when the contaminant particles are dissolved or are smaller than the void spaces in the media via three main mechanisms: interception, sedimentation (gravity settling), and diffusion (which may include sorption). However, limited success in removing TOC and silica from SAGD produced water indicates that the walnut shell filter media are not capable of increasing the efficiency of diffusion or interception. Efficiency of both phenomena can be increased by surface modification of the walnut shell filter.

The present application describes an effective process for improving the deep-bed filtration efficiency by enhancing the sorption capacity of the walnut shell filter particles. This is accomplished by anchoring a low mass fraction of nanoparticles to the walnut shell particles. Interactions between TOC and silica enhances the removal efficiency of the TOC and silica. Having low mass percentages of nanoparticles will enhance the sorption affinity of the walnut shell particles without impacting the rate of wastewater flux through the filtration process. A nanoparticle is a microscopic particle with at least one dimension less than 100 nm.

Iron hydro(oxide) nanomaterials have been extensively used as adsorbents for organic and non-organic matters from various types of wastewater, because they can be efficiently synthesized within wide range of nano-sizes and during the synthesis, their surfaces can be conveniently and efficiently controlled or manipulated by coating or functionalization. Moreover, these nanomaterials have low negative environmental impacts due to low toxicity and biocompatibility. It was recognized by the inventors that iron hydro(oxide) nanoparticles could be generated and hydrothermally anchored to walnut shell particles under controlled conditions with appropriate concentrations of metal precursor and temperature to provide an improved walnut shell filter medium. As used herein, the term “iron hydro(oxide) nanoparticle” refers to a nanoscale crystalline network of various oxygen-bridged iron species in any oxidation state, which are formed upon thermal hydrolysis of simpler iron species such as Fe(OH₂)₆³⁺, and Fe[(OH)(OH₂)₅²⁺, for example. Other iron-based precursors could include iron (III) salts such as Fe(NO₃)₃ or FeBr₃.

The modified walnut shell particles were characterized by scanning electron microscopy (SEM) and compared with the non-modified particles, to confirm the presence of iron hydroxide nanoparticles. Acid digestion followed by an elemental analysis of ICP-OES were performed to quantify the percentages of the nanoparticles on the walnut shell filter. The modified particles synthesized at optimal conditions were found to be capable of removing the high levels of silica and TOC from SAGD wastewater in batch and continuous adsorption experiments. The removal efficiency for silica and TOC before and after the surface modifications was also determined. Successful application of the modified particles inside the walnut shell filtration unit of a SAGD wastewater treatment process is expected to contribute to remediation of the high levels of silica and TOC without need to provide additional separation processes.

While the description below is focused on an investigation of iron hydro(oxide) nanoparticles anchored to nut shell media, the inventors further recognize that other transition metals and Group IIIA metals, such as aluminum for example, may also be used to generate suitable metal hydro(oxide) nanoparticles that can be anchored to walnut shell particles.

Various embodiments will now be described in the description below. Emphasis is placed on highlighting the various contributions of the features described herein to the functionality of various embodiments. A number of possible alternative features are introduced during the course of this description. It is to be understood that, according to the knowledge and judgment of persons skilled in the art, such alternative features may be substituted in various combinations to arrive at different embodiments.

### Materials and Methods

Materials—Walnut shell filter particles and steam assisted gravity drainage wastewater samples were obtained from local sources in Calgary, Alberta, Canada. For the surface modification, 70% HNO₃, and 97% FeCl₃.6H₂O were used. Both chemicals were purchased from Sigma Aldrich and used as received without any pyrolysis or treatment.

Modification of Walnut Shell Particles—Walnut shell filter media are conventionally used to remove oil from water. In the oil and gas industry, walnut shell filters are designed for loadings under 100 mg/L oil and 100 mg/L suspended solids and operate with 90-95% oil removal efficiency. Alternative nut shells include but are not limited to, pecan shells.

Surface modification of walnut shell particles was carried out in two successive reactions; (i) a reaction of the walnut shell particles with an oxidizing agent, followed by (ii) a reaction to anchor iron hydro(oxide) nanoparticles to the walnut shell particles via a thermal hydrolysis reaction.

In the first step, the walnut shell particles were oxidized with 10% HNO₃. The reaction was carried out by adding 50 g of the walnut shell filter particles to 70 mL of 10% HNO₃ in a 200-mL glass container. Then, the container was partially closed and placed under a fume hood for 3 h. Then the acid treated walnut shell particles were washed with deionized water and dried under vacuum overnight. In the second step, 10 g of acid-treated walnut shell particles was added to 500 mL of either 1 M or 2M FeCl₃.6H₂O under magnetic stirring for 5 h inside a sealed plastic container. Thermal hydrolysis was carried out by placing the container inside a pre-heated furnace at either 80° C. or 100° C. for 4, 8 or 12 hours to promote the hydrothermal reaction. The reaction generates walnut shell particles with anchored iron hydro(oxide) nanoparticles. During the synthesis, anchoring of iron hydro(oxide) nanoparticles to the walnut shell surface was controlled by three main factors: concentration of the precursor FeCl₃.6H₂O, hydrolysis time and temperature. Twelve individual experiments were performed for synthesis of the walnut shell particles with anchored iron hydro(oxide) nanoparticles. After the hydrolysis reaction, the walnut shell particles with anchored iron hydro(oxide) nanoparticles were recovered, washed, and dried prior to characterization and testing for removal of TOC and silica.

Characterization of Walnut Shell Particles with Anchored Iron Hydro(oxide) Nanoparticles—To characterize the surface changes occurring for the walnut shell particles after the acid treatment and anchorage of the iron hydro(oxide) nanoparticles, a field emission Quanta 250 scanning electron microscopy analysis (SEM) was performed for the samples: untreated walnut shell particles (WS-VR), acid-treated walnut shell particles (WS-AT), and walnut shell particles with anchored iron hydro(oxide)nanoparticles (WS-NPs) to confirm the presence of iron hydro(oxide)nanoparticles following the anchoring procedure. For the analysis, a small amount of each sample was deposited over a carbon tape sample holder. The holder then was tapped to release an extra amount of each sample. After imaging the surface of the walnut shell particles, X-ray diffraction (XRD) analysis was performed for WS-VR before and after surface modifications using a Rigaku ULTIMA III X-ray diffractometer with Cu Kα radiation as the X-ray source. The X-ray scans were performed in the range of 2 to 90 degrees of 2θ using a 0.05-degree step and a counting time of 1.0 degree per min, operating at 40 kV and 44 mA to obtain the full diffractogram for the analyzed material. Furthermore, Fourier-transform infrared spectroscopy (FTIR) measurements were made for the three samples to confirm anchoring of the iron hydro(oxide) nanoparticles to the walnut shell surface, using an IRAffinity-1S spectrometer (Shimadzu Corporation). The FTIR spectrometer was operated in the diffuse reflectance mode in the range of 4000-400 cm⁻¹ with 4 cm⁻¹ resolution to provide spectra with an average of 50 scans. Potassium bromide (KBr) was used to disperse the powder sample (2 mg per 200 mg, 1% w/w). After that, the iron content of each sample was quantified by a microwave assisted acid digestion (MARS) analysis monitored by inductively coupled plasma optical emission spectroscopy (ICP-OES). For the MARS analysis, a commercial procedure was used as implemented by model MARS 6 unit (CEM cooperation, Matthews, N.C., USA). For the analysis, each solid sample (WS-VR, WS-AT, and WS-NPs) was weighed and mixed with 10 mL of 70% HNO₃ inside 100 mL-plastic vessels (polyethylene). Then the contents of each vessel were digested inside the MARS unit operating at frequency of 2.45 GHz at 100% of full power (maximum of 1600 W). After the acid digestion, the residual concentration of iron and silica for each sample was measured by a Thermo Scientific ICAP series ICP-OES spectrometer. Calibration curves for the iron and silica were generated using Dashboard-iCAP 7200 with ASX560 with respect to iron and silica standard solutions, which were purchased from Sigma Aldrich at purities of 99.5% and 98%, respectively.

Batch Removal of TOC and silica from a SAGD Wastewater Sample—TOC and silica removal was tested for the WS-VR, WS-AT, WS-NPs using batch-mode adsorption. Each experiment was performed by adding a fixed amount of each material (100 mg) to a series of 25-mL glass vials filled with 10 mL of SAGD wastewater solution with a concentration of silica of 145 mg/L and TOC 410 mg/L. The vials were then sealed and placed in a Wrist Action shaker (Burrel, Model 75-BB) for 4 hours, which was a sufficient period to attain equilibrium. After that, the vials were left overnight on a lab bench at room temperature to allow the materials to settle down. After settling, all vials were centrifuged for 10 min at 5000 rpm in an Eppendorf centrifuge 5804 to separate the residuals after the batch adsorption experiments. The residual concentrations of TOC and silica were measured by using the TOC (TOC-L CPH/CPN) analyzer and ICP-OES, respectively. Then the percentage removal of silica and TOC for each sample were calculated as follows:

$$\% Removal = \frac{{C}_{i n} - {C}_{f}}{{C}_{i n}} \times 100 \qquad ( equation 1 )$$

Additionally, the adsorbed amount (Qₑ) in mg/g can be also determined by applying the mass balance as follows:

$${Q}_{e} = \frac{V}{m} ( {C}_{i n i tial} - {C}_{e} ) \qquad ( equation 2 )$$

where V, m, and Cₑ are the volume of solution (mL), the mass of adsorbent (g), and the equilibrium concentration (mg/L), respectively. The maximum adsorption capacity in addition to kinetic parameters for the removal of silica and TOC were determined by performing the batch adsorption experiments at various dosages of WS-NPs. Then, the obtained equilibrium data were plotted to estimate the batch adsorption isotherm. The adsorption isotherm data were described by the Sips model, which is commonly known as Freundlich-Langmuir combined model, as represented by the following equation:

$${Q}_{e} = \frac{k {Q}_{m} {C}_{e}^{n}}{1 + k {C}_{e}^{n}} \qquad ( equation 3 )$$

where k, Qₘ, and n , respectively, are Sips equilibrium constant (L/mg)ⁿ, maximum adsorption capacity (mg/g), and heterogeneity coefficient (dimensionless) that express the sensitivity of the model towards Langmuir or Freundlich tendency. The model tends to be fully Langmuirian if the n value is equal to one. Having n=zero indicates the Freundlich isotherm model. The Sips equation allows description of a system with single molecule adsorbed per site where adsorbed molecules can interact as well. The duality of the Sips equation is apparent as it approaches the Langmuir model as n approaches 1 (implying homogeneity) or Freundlich as n approaches zero (implying heterogenicity).

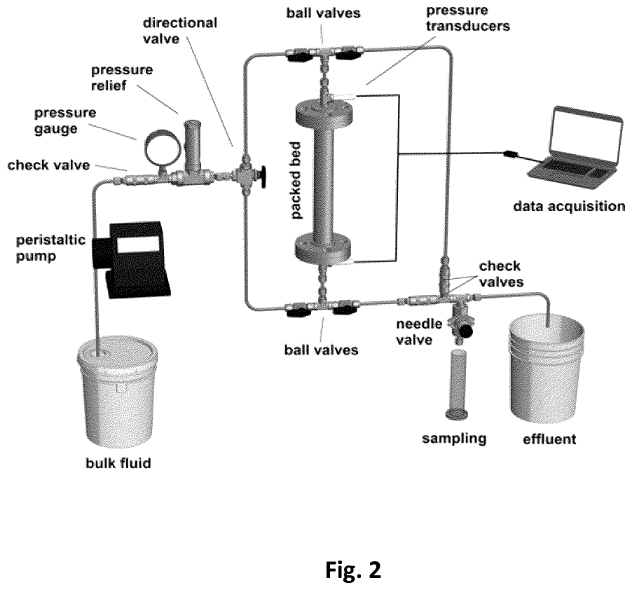

Fixed-bed Column TOC and Silica Removal—After performing the batch adsorption tests, silica and TOC removal were also tested for the walnut shell particles, before and after modifying the surface with a low mass fraction of nanoparticles, in a continuous flow mode using a fixed bed column. FIG. 2 shows a schematic representation of the experimental setup. The column set-up is composed of five main parts: a packed-bed column, pressure transducers, a peristaltic pump, an influent tank and an effluent tank. These parts are connected together through a well-designed piping system (quarter inch PVC tube) inside a stainless-steel frame. The column has an inner diameter of 1 cm and height of 8 cm. Two pressure transducers are located at the inlet and outlet of the column and both of them are connected to a computer where the pressure drop in the column was determined and recorded throughout the experiments. The piping system connected the column with the pump, the influent tank and the exit tank through a set of valves (check, directional control and ball valves). Ahead of the effluent tank, a needle valve was installed for sampling. The peristaltic pump was a manual pump with 7 atm (100 psi) Santoprene ReNu Pumphead (head to the left). Before each experiment, the column was supported and closely packed from the bottom and top by a 1 cm mesh layer. Then, the column was filled with each material (WS-VR and W-NPs) individually until a desired length was obtained. After filling, the column was initially flushed with deionized water and each experiment was started by providing a uniform flow rate to the column from the top. The effluent was collected periodically from the bottom of the column during each experiment. Then the TOC and silica concentration of each sample was measured by the TOC and ICP-OES at different time intervals. The obtained concentration values are presented in form of a breakthrough curve for each material and compared in terms of breakthrough time and removal efficiency. The breakthrough time was obtained when the effluent concentration (Cₜ) was approximately equal to 0.05 of the influent concentration (Cₒ). Each experiment was stopped based on the achieved differential pressure or the effluent wastewater quality. Worth noting here is that the flux was selected based on a typical flux of the industrial scale of walnut shell filter that has typical diameter of 4.26 m (14 ft) and operates under minimum flux of 0.067 m³/s (1077.02 gpm).²⁴ To mimic the flow through the commercial filter, a dimensionless number analysis was applied to the column to determine the column running flow regime. Assuming that the physical properties for the wastewater are similar to water at 25° C. and that the porosity of the walnut shell particles is 0.7, the obtained Reynold number (Re) was determined to be 13. With the Re value, the column, as a pilot scale for the commercial filter, should operate at minimum flow rate of 22.5 mL/min. Accordingly, the column tests were performed at volumetric flow rates (Q) of 10, 20, and 30 ml/min with constant initial concentrations of silica (155 mg/L) and TOC (450 mg/L) and a bed depth of 8 cm. For industrial purposes, the quality of the SAGD produced water was also considered as an important hydrodynamic parameter. Thus, the change in the inlet concentrations of silica and TOC was focused on in the column study, such that the inlet TOC concentration was 450, 225, and 150 mg/L, while the inlet concentration of silica was 155, 77.5, 51.6 mg/L. Furthermore, the column study included the bed height (Z) effect on the breakthrough behavior with bed heights of 4, 6, 10 inches (i.e., 10.2, 15.2, and 25.4 cm).

TABLE 2
Characteristic parameters of the experimental breakthrough curves.

| Parameter | Description | Expression |
|---|---|---|
| tₜ (min) | Total time | ${\int }_{t = 0}^{t = ∞} ( 1 - \frac{{C}_{t}}{{C}_{o}} ) dt$ |
| qₜₒₜₐₗ (mg) | Total adsorbed quantity | $( \frac{Q {C}_{o}}{1000} ) {\int }_{t = 0}^{t = ∞} ( 1 - \frac{{C}_{t}}{{C}_{o}} ) dt$ |
| Mₜₒₜₐₗ (mg) | Total amount sent to column | $( \frac{Q {C}_{o}}{1000} )$ |
| % Removal | Total removal percentage | $( \frac{{q}_{total}}{{M}_{total}} ) \times 100$ |

Cₜ = outlet concentration (mg/L), Cₒ = inlet concentration (mg/L), Q = volumetric
flow rate (mL/min), Hₜ = total bed height (cm), t_{b} = breakthrough time (min), and
tₜₒₜₐₗ = total time (min).

Recyclability and regeneration/backwashing of the filtration media is a necessary and critical step. In the real field, the regeneration of the walnut shell filter is part of the filtration cycle and can be triggered by one of the following: (1) the quality of the water outlet, (2) the pressure drop profile, and (3) the pre-set time for the filtration stage. In many deep filtration sites, the backwash is either performed inside the same vessel or in a separate vessel.³⁶ However, direct backwashing of the saturated walnut shell filtration column is technically challenging and requires a significant amount of energy and fresh water since the oil does not directly get adsorbed in the media and tends to be agglomerated in an event known as “mud balling”. Thus, injecting fresh water in a direction opposite to that of the filtration stage, even at high volumetric flow rate, is not sufficient. In fact, every cycle requires agitation of the complete bed of the media in a violent turbulent fashion. Recently, three backwashing modes have been reported to regenerate the dirty walnut shell media from the oilfield wastewater filter: fluidization, hydraulic swirling, and blade stirring.²⁵ The results showed that blade stirring, compared with the other backwashing methods, is the most effective backwashing method with the least water consumption. The regeneration was performed using two primary methods: direct backwashing and blade stirring. The direct backwashing was done by reverse-injecting a very diluted sodium hydroxide solution (1 mM) to the spent filter at high flow rate. This experiment was done on the spent column that was obtained at Q=10 mL/min, Z=4 in, and C_{o,TOC}=155 and C_{o,Silica}=450 mg/L. After a specified time (attaining clean samples from the outlet), the backwashing stopped, and the flow reversed for the second cycle with the original SAGD produced water sample at the same conditions. After saturation, the column flow was stopped, and the same backwashing procedure was repeated for three regeneration cycles. Furthermore, the blade stirring method was also applied in our regeneration study for spent filter that was obtained at Q=10 mL/min, Z=6 in, and C_{o,TOC}=155 and C_{o,Silica}=450 mg/L. The blade stirring regeneration method was conducted by recovering the spent material after shutting down the column. Prior to the recovery, the spent WS-NPs were soaked with 40 mL sodium hydroxide (0.1 mM) at pH=6 and stirred by the mixer at 500 rpm for 5 min inside a 50 mL plastic bottle. After that, the recovered material was filtered under a vacuum and washed 3 times with fresh water to be reused for the next cycle. During the next cycle, the column was run at the same operational parameters as the first cycle and the clean water was periodically collected until the column was saturated. The same regeneration procedure was repeated for the second and third regeneration cycles.

### Results and Discussion

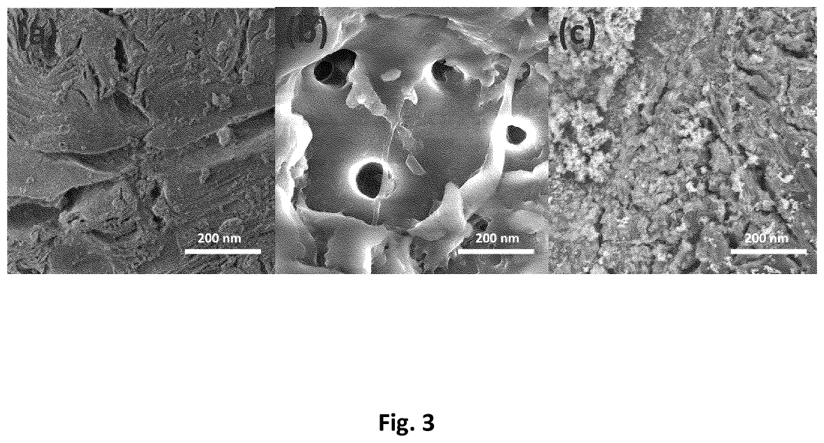

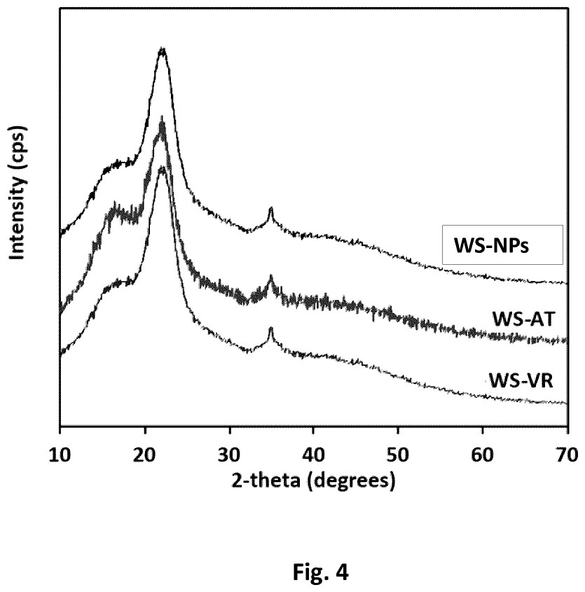

Characterization—FIGS. 3(a) to 3(c) are SEM micrographs of the walnut shell medium before and after acid treatment and surface modification to provide anchored iron hydro(oxide) nanoparticles. Significant structural changes on the walnut shell surface can be seen in the images taken before (FIG. 3(a)) and after acid treatment (FIG. 3(b)) and anchoring of iron hydro(oxide)nanoparticles (FIG. 3(c)). It can be seen that prior to anchoring of the iron hydro(oxide) nanoparticles to the walnut shell surface, the surface of the fibrous walnut shell material has several sharp fissures (FIG. 3(a)). Following acid treatment, irregular shapes and pores are generated (FIG. 3(b)). FIG. 3(c) indicates the presence of the iron hydro(oxide) nanoparticles, indicating that that acid treatment provides anchoring and diffusion sites for attachment of the iron hydro(oxide) nanoparticles. XRD patterns of walnut shell before (WS-VR) and after surface modifications (WS-AT and WS-NPs) are shown in FIG. 4. The diffraction peaks for WS-VR do not reflect anything beyond the low crystallinity walnut shell XRD pattern. However, the diffraction peaks obtained at a 2-theta value of approximately 23 degrees appear to have been affected by the hydrothermal treatment of the WS-VR. Also, no diffraction peaks corresponding to the iron hydro(oxide) nanoparticles were observed, indicating a high dispersion and low mass fraction with respect to the walnut shell particles (consistent with previous SEM results).

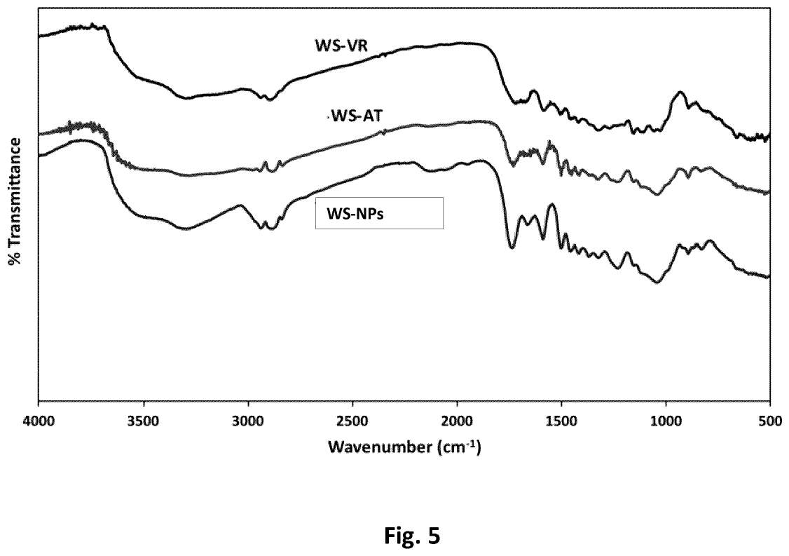

Furthermore, FTIR measurements were performed for the same samples (WS-VR, WS-AT, and WS-NPs) to confirm anchoring of iron hydro(oxide) nanoparticles to the walnut shell particle surface in the range of 400-4000 cm⁻¹ (FIG. 5). A wide band with maximum intensity at 3405 cm⁻¹ was obtained for the three signals which is assigned to the stretching of O—H group of the macromolecular association. Significant bands are also located at approximately 2925⁻¹ and 2854 cm⁻¹ with different intensities. These bands are assigned to stretching of the —CH₂— and —CH— bonds of methylene groups in the walnut shell structure. However, the broadness of this band was found to be narrower in the WS-AT and WS-NPs samples. In the WS-AT sample, the sharp bands observed at 1708 cm⁻¹ and 1622 cm⁻¹ indicate stretching vibrations of a carboxylic acid which participates in an intermolecular hydrogen bond. In addition, the sharp peaks observed in the WS-VR sample at 1510 cm⁻¹ and 1458 cm⁻¹ are assigned to C═C ring stretch of aromatic rings. Several bands ranging from 1319 cm⁻¹ to 1051 cm⁻¹ are assigned to C—O bonds of phenols. This splitting pattern is characteristic of several different C—O bonding modes of different phenols, confirming the presence of polyphenolic biomolecules such as tannins.

These results provide an indication that the iron hydro(oxide) nanoparticles interact with the active groups OH of phenolic groups, as well as the COOH of carboxylic acids on the surfaces of the walnut shell particles.

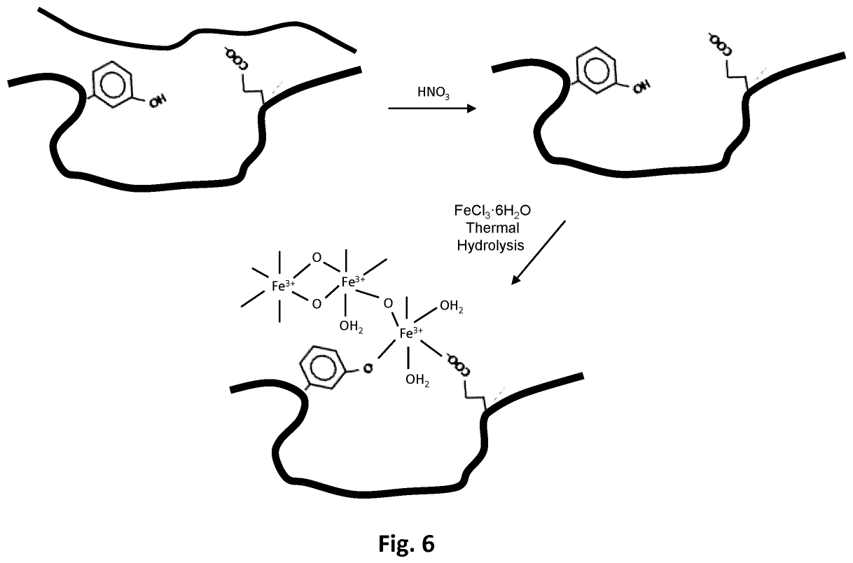

Without being bound to any particular theory, it is believed that the acid treatment effectively removes a relatively inert surface layer of the nut shell to expose a porous surface which increase the surface area of the outer layer, thereby exposing greater quantities of carboxylic acids and phenolic groups which can react with the nanoparticles (see FIG. 6).

Upon anchoring of the iron hydro(oxide) nanoparticles to the surfaces of the walnut shell particles via thermal hydrolysis, the bands observed at 2925 cm⁻¹, 2854 cm⁻¹ 1708 cm⁻¹, and 1622 cm⁻¹ are reduced in intensity due to reduction in carboxylic acid groups. Thus, the iron cations tend to interact with the oxygenated surface (negatively charged carboxylate groups, or the de-protonated hydroxyl groups) as illustrated in FIG. 6. For WS-NPs, a vibration band was obtained at 586 cm⁻¹ which is assigned to stretching of a Fe—O bond provides evidence of successful anchoring of walnut shell particles with iron(hydroxide) nanoparticles.

To gain better insights into the anchoring mechanism of the iron cations and the oxygenated walnut shell surface, the hydrolysis conditions at which the iron hydro(oxide) is formed is described in FIG. 6 were further investigated. Generally, when the ferric salt is dissociated to ferric ions, a number of parallel and sequential reactions are carried out.^{26,27} Then, the iron (III) cations tend to form hexa-aqueous complexes (Fe(OH₂)₆³⁺ as per Reaction 1²⁸

FeCl₃.6H₂O(s)→Fe(OH₂)₆³⁺(aq)+3Cl⁻ (Reaction 1)

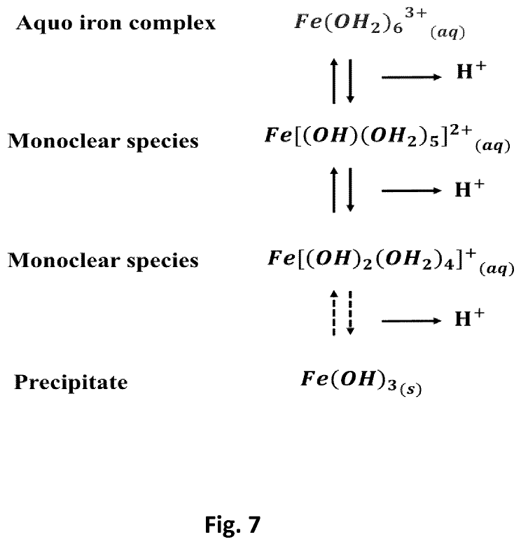

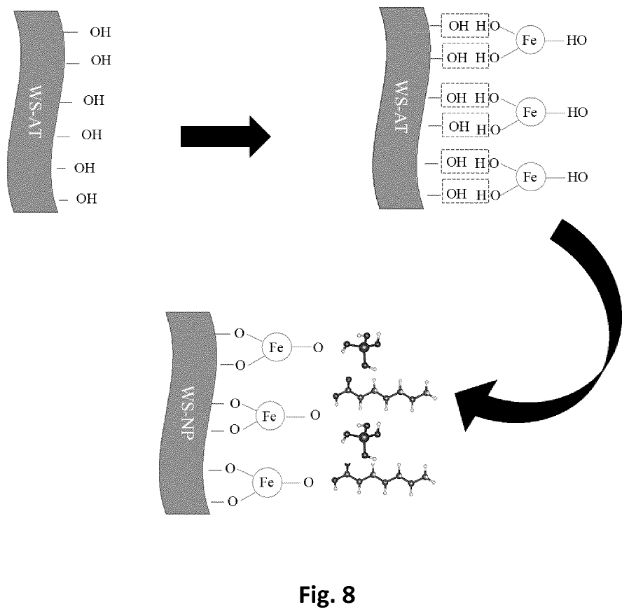

such that the water molecules are coordinately bonded to the metal cation. The formed hexa-aqueous complexes pass through a series of hydrolytic reactions as illustrated in FIG. 7, which give rise to the formation of variety of soluble mono-clear and precipitate species.^{26,27} These species are generated due to reduction of the O—H bonds in the coordinated water molecules, which tend to act as a Bronsted acid in the aqueous solution (protons donor).^{26,27} Thus, the H₂O ligands presented in the aquo complex tend to be ultimately deprotonated in a step wise process to form other mono-clear soluble (i.e. Fe(OH)(OH₂)₅²⁺ and Fe(OH₂)(OH₂)₄⁺ and precipitate (i.e. Fe(OH)₃) species as presented in FIG. 4. Hence, there is some uncertainty regarding the species involved in anchoring the hydroxylated particles (i.e. WS-AT). According to some previous studies, two possible scenarios can be suggested to represent the interaction between the formed species and the hydroxylated particles (i.e. WS-AT).^{35,46} In the first scenario, interaction of hydroxylated particles can be induced with any mono-clear species by forming oxygenated bridges through a nucleophilic substitution mechanism as suggested by Nieto-Delgado and Rangel-Mendez (2012),²⁸ On the other hand, Zhu et al(2020),²⁹ have proposed that the precipitate species of iron hydroxide Fe(OH)₃ can be bounded to the hydroxylated surface by bidentate adsorption as schematically presented in FIG. 8. The authors have proven via experimental and theoretical DFT calculations that the interaction between Fe(OH)₃₍ₛ₎ and a hydroxylated surface of bastnaesite occurs through the bidentate adsorption.²⁹ This bidentate adsorption will lead to the reduction of active sites, that is, there is a situation that two rare earth cation sites are reduced to one ferric ion site. According to such mechanism, the Fe(OH)₃ nanoparticles chemically adsorb onto the hydroxylated surfaces and form a more stable and reactive structure,²⁸⁻³⁰ which allows the surface to remove silica and TOC simultaneously, as will be discussed in the next sections.

Batch removal of TOC and Silica—Table 3 lists the weight percentages of iron, which were obtained by MARS analysis followed by ICP-OES through surface modification of the walnut shell particles after controlling the factors of the concentration of initial iron precursor, hydrolysis temperature and time.

TABLE 3
Weight percentages of iron, Percentage Removal of Silica
and TOC, and Leached Amount of Iron (mg/L) for the Walnut
Shell Samples Obtained Under Various Conditions

| Hydrolysis | Hydrolysis | Iron precursor | | | | |
|---|---|---|---|---|---|---|
| time | temperature | Concentration | | % Removal | % Removal | Leaching |
| (hours) | (° C.) | (M) | % Fe | TOC | silica | (mg/L) |
| 4 | 80 | 1 | 0.96 | 80.20 | 82.20 | 4.200 |
| | 100 | 1 | 1.7 | 93.40 | 92.30 | 8.900 |
| 8 | 80 | 1 | 1.2 | 89.90 | 87.67 | 9.500 |
| | 100 | 1 | 2.1 | 88.60 | 90.90 | 14.60 |
| 12 | 80 | 1 | 1.5 | 91.67 | 91.20 | 0.123 |
| | 100 | 1 | 6.2 | 78.00 | 86.70 | 34.40 |
| 4 | 80 | 2 | 1.7 | 88.80 | 91.20 | 0.102 |
| | 100 | 2 | 2.2 | 86.30 | 86.95 | 0.732 |
| 8 | 80 | 2 | 2.9 | 85.40 | 85.70 | 20.00 |
| | 100 | 2 | 3.3 | 92.60 | 87.00 | 20.70 |
| 12 | 80 | 2 | 3.7 | 86.30 | 87.46 | 35.38 |
| | 100 | 2 | 8.2 | 88.00 | 84.00 | 44.60 |

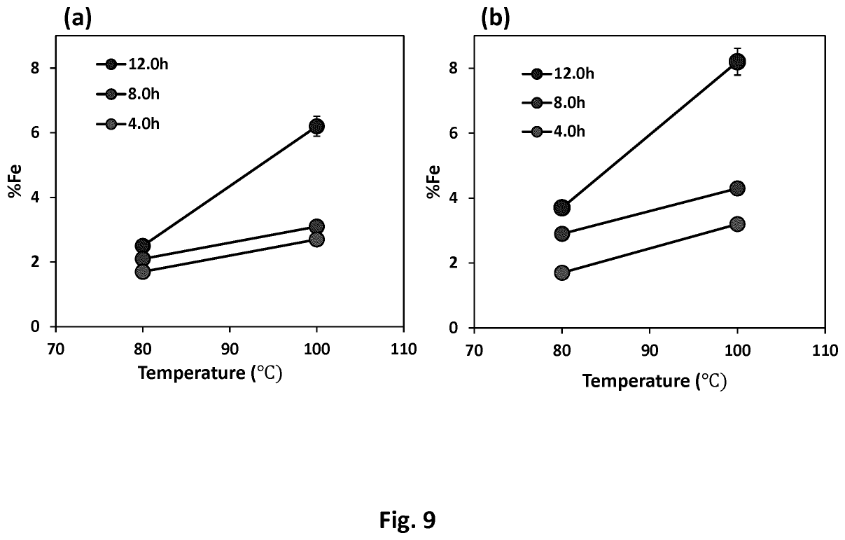

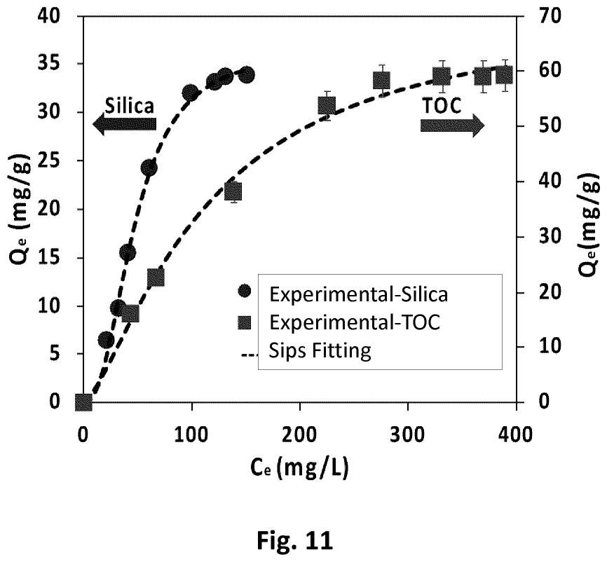

FIG. 9 shows plots of iron weight percentages for WS-AT-PNs obtained over a range of temperatures and hydrolysis reaction periods of 4, 8, and 12 hours with different initial concentrations of iron precursor; 1 M FeCl₃.6H₂O in FIGS. 6(a) and 2 M in FIG. 6(b). This data set confirms that increasing the hydrolysis time contributes to enhancement of the weight percentages of iron incorporated into the modified walnut shell media. The hydrolysis reaction in the batch reactor provides greater amounts of anchored iron hydro(oxide) with longer reaction times. Furthermore, at high hydrolysis temperatures and high concentrations of iron precursor, the endothermic equilibrium reaction favors production of iron hydro(oxide) nanoparticles. These nanoparticles were expected to provide enhancement of removal of TOC and silica. The batch removal study showed a considerable enhancement in the removal of silica and TOC with higher mass fractions of iron hydro(oxide) nanoparticles loaded onto the walnut shell particles. However, loading greater amounts of nanoparticles did not provide an increase in the rate of removal of silica and TOC in all cases. This might be due to poor dispersion of the nanoparticles on the surface as well as anchoring of nanoparticles inside micropores which are not efficiently accessed by TOC and silica. On the other hand, loading significant amounts of hydroxide nanoparticles on the walnut shell surface might lead to blockage of the porous media under continuous operation. Thus, it is not highly recommended to enhance the loading efficacy especially at an industrial scale. Accordingly, the optimized WS-NPs used for the rest of the batch and continuous sorption experiments is anchored with an initial concentration of iron precursor of 1 M and hydrolysis temperature of 100° C. for 4 h. After comparing the performance towards removal of silica and TOC, the optimized WS-NPs were used to construct adsorption isotherms for the silica and TOC at temperature of 25° C. and pH 8.9. FIG. 11 includes the experimental adsorption isotherms obtained for the TOC and silica along with their fitting with Sips model (dashed lines). As shown, the Sips model describes the experimental data very well. The degree of fitting the experimental data was also determined statistically using the non-linear Chi-square analysis (χ²) by minimizing the sum of squares of the differences between the experimental values and the predicted values using Origin Pro 8 SR4 software Version 8.095. The estimated χ² value was 0.001. This low value of χ² confirms that the Sips model describes adequately the experimental data. From the non-linear fitting, it was obtained that maximum monolayer uptake for TOC and silica were approximately 72 and 37±2 mg/g, respectively. Table 4 lists the fitting parameters obtained through fitting the experimental adsorption isotherms with the Sips model. It can be seen that the values of n are greater than one, indicating the heterogeneity of the surface and presence of interactions between the silica and TOC.

TABLE 4
Equilibrium Sips isotherm parameters for the simultaneous
adsorption of TOC and silica on WS-NPs at 293K and pH 8.9

| Sips parameter | TOC removal | Silica removal |
|---|---|---|
| Qₘ (mg/g) | 71.6 | 36.5 |
| K ((L/mg)ⁿ) | 0.0031 | 0.0001 |
| n (unitless) | 1.40 | 2.38 |
| X² (unitless) | 0.0015 | 0.0008 |

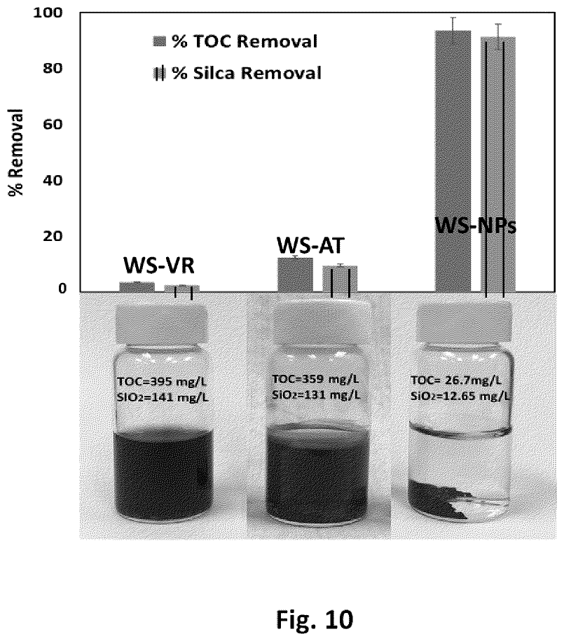

FIG. 10 shows results of TOC and silica removal for walnut shell filter media before and after surface modification by acid treatment and by anchoring 1.7% iron hydro(oxide) nanoparticles in the batch sorption experiments. The figure also includes three photographs to show the appearance of SAGD wastewater sample after treatment with the walnut shell medium before treatment (WS-VR), after acid treatment (WS-AT) and with the anchored iron hydro(oxide) nanoparticles (WS-NPs). Removal of silica and TOC is most effective in the presence of iron hydro(oxide) nanoparticles, where the dark black SAGD wastewater sample is rendered transparent. The WS-NPs sample reduces both TOC and silica by about 85%.

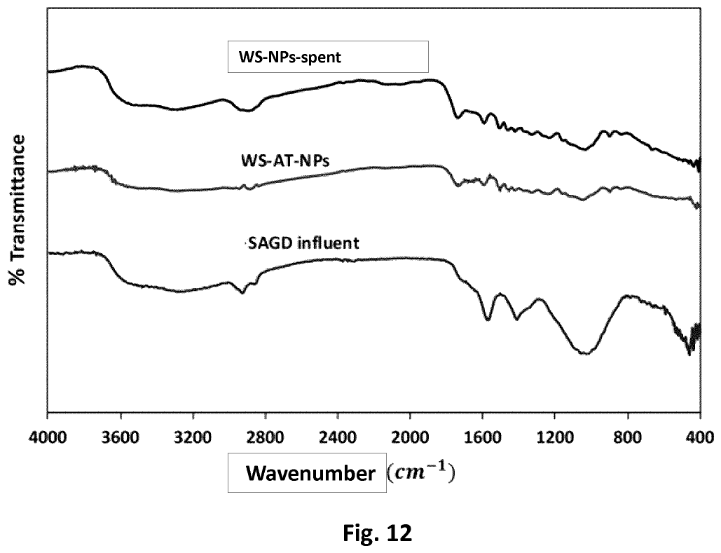

Changes in functionality of the WS-NPs before and after the batch sorption tests was determined by the FTIR analysis and the spectra for each sample are compared to the spectrum of a dried SAGD wastewater sample (SAGD influent) in FIG. 12. There are significant differences in the spectra. For the non-modified SAGD influent wastewater sample, infrared bands at 1595 cm⁻¹ and 1392 cm⁻¹ are attributed to symmetric and asymmetric stretching bonds of the carboxylate groups and the bands at 2920 cm⁻¹ and 2820 cm⁻¹ arise from symmetric and asymmetric —CH₂— stretching of the hydrocarbons in the SAGD wastewater. The band at 1302 cm⁻¹ is assigned to C—N stretching. Also, other bands obtained for SAGD influent at 3250 cm⁻¹, 2951 cm⁻¹, 1630 cm⁻¹, 1550 cm⁻¹, 1400 cm⁻¹ and 1010 cm⁻¹ are characteristic of hydroxyl, amine, methylene, carbonyl, and carboxylate functional groups. All of these bands arise from dissolved organic matter in the SAGD wastewater representing total organic carbon (TOC). On the other hand, the assigned bands at 475 cm⁻¹ and 694 cm⁻¹ are assigned to asymmetric and symmetric bending of Si—O. In addition, other lower intensity bands at 778 cm⁻¹ and 797 cm⁻¹ are assigned to stretching symmetric Si—O. The bending and stretching bands for Si—O can be considered as evidence for the presence silica in SAGD wastewater. It is notable that the infrared band assigned to Fe—O at 586 cm⁻¹ in WS-NPs tends to be reduced and less visible after the sorption test (in WS-NPs-spent), confirming the functionality change after the batch sorption test. This functionality change is also indicated by the appearance of bands at 670 cm⁻¹, 2870 cm⁻¹, and 3250 cm⁻¹, confirming the interaction of various functional groups with TOC and silica. Fundamentally, the term TOC in SAGD produced water refers to the soluble organics, which can be classified into dissociable or non-dissociable organics.²⁸ The first term describes the organic molecules that might be dissociated into ionic forms, including phenols, monocarboxylic acids and dicarboxylic acids. The non-dissociable organics are the non-ionic soluble oil fraction and glycols. Both types of soluble organics are naturally anionic and tend to form neutralized colloids at low pH via protonation, or positively charged metal ions (iron hydro(oxide) nanoparticles).²⁴

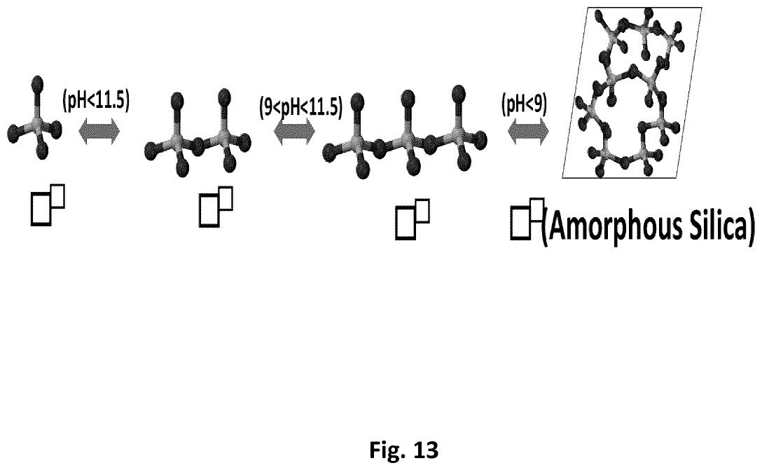

Dissolved silica, on the other hand, has many stable and unstable species that can exist under aqueous conditions. Soluble silica contains various silica species; monomers, dimers, trimers, and polymeric silicic acid.²⁷ Based on a medium pH range and the presence of other ions, the silica species are in transition between the species (see FIG. 13).²⁷ With polymerization of silicic acid by condensation, a three-dimensional gel network of insoluble or colloidal silica (amorphous silica) is formed. The behavior of various forms of silica is said to be anomalous because stability dependence on pH does not follow a reliable trend.²⁷ It has been found that silica species in equilibrium with the amorphous form consist of two domain states of silica which depend on pH and silica concentration.³² The first domain is the colloidal domain which is polymerized and insoluble.³² The second domain is mono-clear sodium silicate containing Si(OH)₄, Si₂(OH)₃²⁻, and Si₄O₅(OH)₅²⁻. Up to pH 9, the dominant mono-clear form is [Si(OH)₄]. Then, ionization of dissolved silica species increases above pH 9. Within a pH range between 9.0-11.5, the concentration of mono-clear domain silica and other species are the dominant in an aqueous condition.³² Thus, in the presence of Fe³⁺ iron hydro(oxide) nanoparticles, the anionic species of silica tends to interact with the surface of the walnut shell particles. These findings are in agreement with previous reports by Manceau et al. (1995),³² Luo and Wang (2001),³³ and Pedenaud et al. (2005).¹³ These reports indicate that silica can form a Fe—Si—Fe linkage in the presence of trivalent ions such as Fe³⁺ and Al³⁺.^{13,34-35} While Pedenaud et al. reported enhancement in removal of silica via addition of FeCl₃ and NaOH.¹³

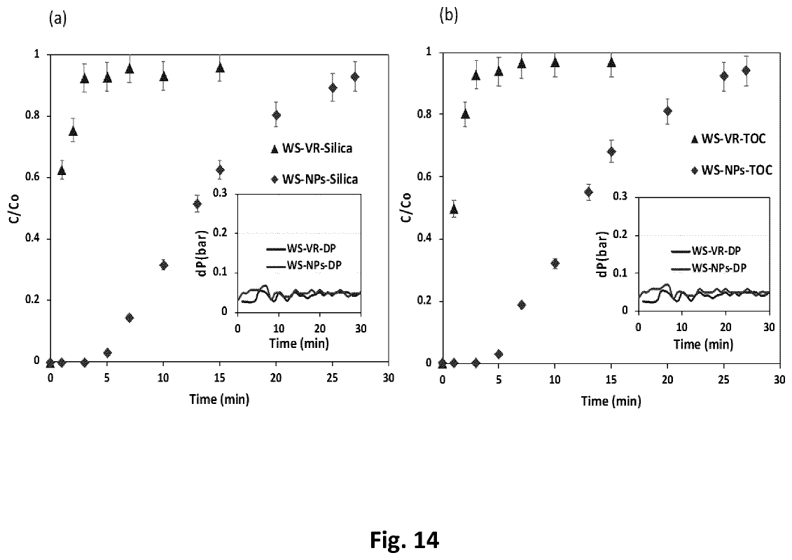

Removal of TOC and Silica using a Fixed-Bed Column—Breakthrough profiles for the removal of TOC and silica, that were obtained from the fixed-bed column experiments through packing the column with WS-VR and WS-NPs at constant initial concentrations of silica (155 mg/L) and TOC (450 mg/L), bed depth of 4 in, flow rate of 10 mL/min, and pH 8.90, are shown in FIG. 14. The figure also includes the pressure drop (bar) against time (min), which were obtained through each column experiment. As seen, the experimental data followed the typical behavior of the breakthrough curves. However, the virgin walnut shell particles, without iron hydroxide nanoparticles, had low sorption affinity for TOC and silica from SAGD wastewater, with estimated t_{b} value<1 min. However, more effective removal TOC and silica occurred in the presence of nanoparticles, with an estimated t_{b} value of 6 min. Thus, the TOC and silica were initially removed, resulting in colorless effluent samples for almost 10 min. As the column operates, the effluent concentration started to break through (Cₜ=0.05 Cᵢₙ) and increased until it is exhausted, where the effluent samples tended to become darker. Furthermore, the pressure-drop measurements inside the column that confirmed that presence of nanoparticles did not significantly contribute to the pressure drop, such that its value was less than 0.1 bar. Thus, presence of nanoparticles on the walnut shell surface did not cause mud-balling or a channeling effect before the saturation of the column during the operation. These results are considered as robust evidence that the modified walnut shell filter media has a strong ability to improve the performance of the commercial walnut shell filter after optimizing the operational parameters. These interesting results motivated us to study the effects of the other hydrodynamic loading conditions of silica and TOC (Q, Cₒ and Z) in the breakthrough behavior of WS-NPs and the mechanism controlling the mass transfer inside the column.

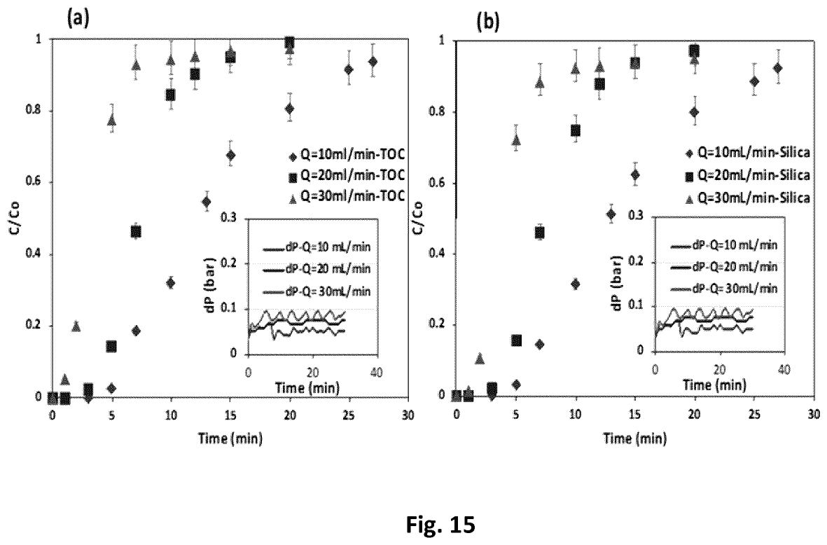

FIGS. 15-17 show the experimental breakthrough curves (BTCs) obtained for the removal of TOC and silica from the column tests by varying the hydrodynamic loading parameters of Q, Co, and Z. All the BTCs include pressure drop profiles that were obtained during the column operations (the inset graphs).

TABLE 5
Breakthrough curves (BTCs) experimental conditions, designed
parameters, fitting parameters with dimensionless convection
axial dispersion model together with standard error
analysis of the fitting in the form of χ2 for the
TOC removal inside the fixed bed column

| Experimental Conditions | | | Designed parameters | | |
|---|---|---|---|---|---|
| Q | Cₒ | Z | t_{b} | tₜ | % |
| (mL/min) | (mg/L) | (cm) | (min) | (min) | Removal |
| 10.0 | 450 | 10.2 | 6.0 | 16.5 | 61.1 |
| 20.0 | 450 | 10.2 | 4.0 | 13.5 | 58.6 |
| 30.0 | 450 | 10.2 | 3.0 | 11.5 | 57.5 |
| 10.0 | 225 | 10.2 | 8.0 | 20.5 | 62.1 |
| 10.0 | 150 | 10.2 | 12.5 | 26.2 | 65.6 |
| 10.0 | 450 | 15.2 | 11.0 | 23.5 | 56.0 |
| 10.0 | 200 | 25.4 | 17.0 | 33.5 | 67.7 |

TABLE 6
Breakthrough curves (BTCs), experimental conditions, designed
parameters, fitting parameters with dimensionless convection
axial dispersion model together with standard error analysis
of the fitting in form of χ² for the silica removal
inside the fixed bed column.

| Experimental Conditions | | | Designed parameters | | |
|---|---|---|---|---|---|
| Q | Cₒ | Z | t_{b} | tₜ | % |
| (mL/min) | (mg/L) | (cm) | (min) | (min) | Removal |
| 10.0 | 155 | 10.2 | 5.0 | 16.0 | 59.6 |
| 20.0 | 155 | 10.2 | 3.5 | 13.25 | 57.2 |
| 30.0 | 155 | 10.2 | 2.0 | 11.0 | 55.0 |
| 10.0 | 51.6 | 10.2 | 12.5 | 26.2 | 65.5 |
| 10.0 | 77.5 | 10.2 | 8.0 | 20.5 | 62.1 |
| 10.0 | 155 | 15.2 | 11.0 | 23.0 | 56.5 |
| 10.0 | 155 | 25.4 | 17.0 | 33.5 | 67.5 |

Flow rate effect—The performance of any treatment process in continuous mode is significantly affected by the flow rate in the pilot or industrial scale.⁵⁸ FIG. 15 represents the obtained BTCs for the removal of TOC by changing the feed flow rate (10, 20, and 30 mL/min) at constant bed-height (10.2 cm) and inlet concentration of TOC (450 mg/L) and silica (155 mg/L). FIG. 15b also shows the obtained BTCs for the removal of silica under the same operational conditions. All of the BTCs show that the adsorption was initially very rapid and identical for any flow rate, which is associated with the presence of binding sites capable of capturing all of the TOC and silica molecules. The binding sites in the next step are gradually occupied and their uptake became less effective based on the provided flow rate. When the flow rate was increased, the BTC became steeper and the breakthrough time and adsorbed amount of TOC and silica are reduced as shown in Tables 5 and 6. Inside the column, the residence time for attaining the adsorption equilibrium at the high flow rate of TOC and silica molecules is shorter. Consequently, the front of the mass transfer zone reaches the bottom of the column quickly, causing early saturation of the column and leaving more un-adsorbed TOC and silica molecules. The contact time between the adsorbed molecules and WS-NPs is therefore shorter at high flow rates, causing a significant reduction in the removal efficiency. It appears that enhancing the flow rate with similar conditions to the industrial operation (>20 mL/min) did not significantly impact the pressure drop profiles. It appears that enhancing the flow rate with similar conditions to the industrial operation (>20 mL/min) did not significantly impact the pressure drop profiles. This strongly proves that the modified walnut shell particles can be transformative to the currently applied technology.

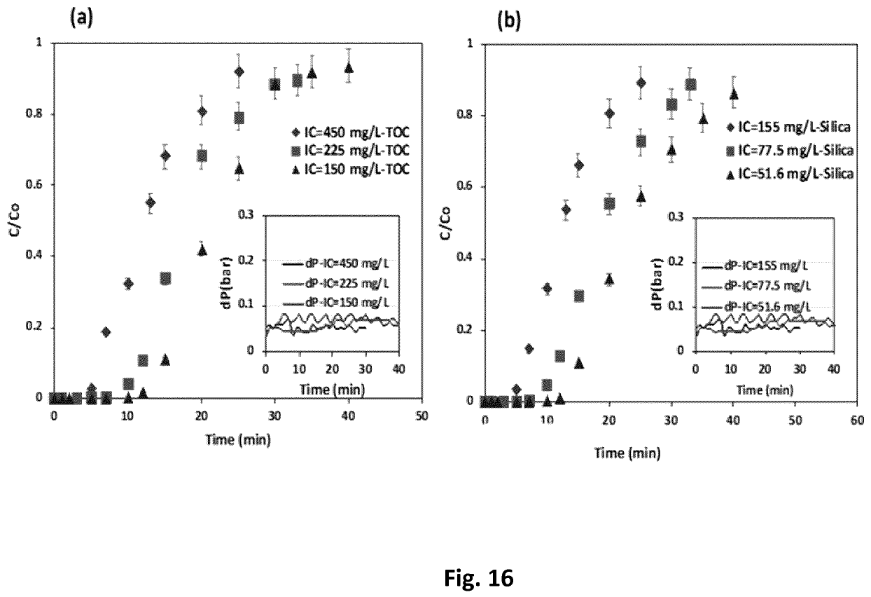

Feed initial concentration effects—The feed quality of SAGD produced water significantly influences the performance of the bed inside the column. Thus, the effect of feed initial concentrations of TOC and silica on the breakthrough behavior was investigated in FIG. 16, such that FIG. 16a and b show the obtained BTCs at different concentrations of TOC (150-450 mg/L) and silica (51.6-155 mg/L), respectively. While the other experimental conditions are kept constants. These results demonstrate that the change in the feed concentration affects the saturation rate and breakthrough times. In brief, the presence of high concentrations of silica and TOC accelerates the saturation of column, which contains limited binding sites. Thus, decreased inlet silica and TOC concentrations provided higher treated volume since the lower concentration gradient caused slower transport due to a lower driving force. This suggests that initial concentration of adsorbate affects the diffusion of adsorbate in the WS-NPs. As a rule of thumb, enhancing the driving force for the mass transfer contributes to a high rate of adsorption and axial dispersion, It is worth noting here that increasing the feed concentration had slight effect on the pressure drop profiles.

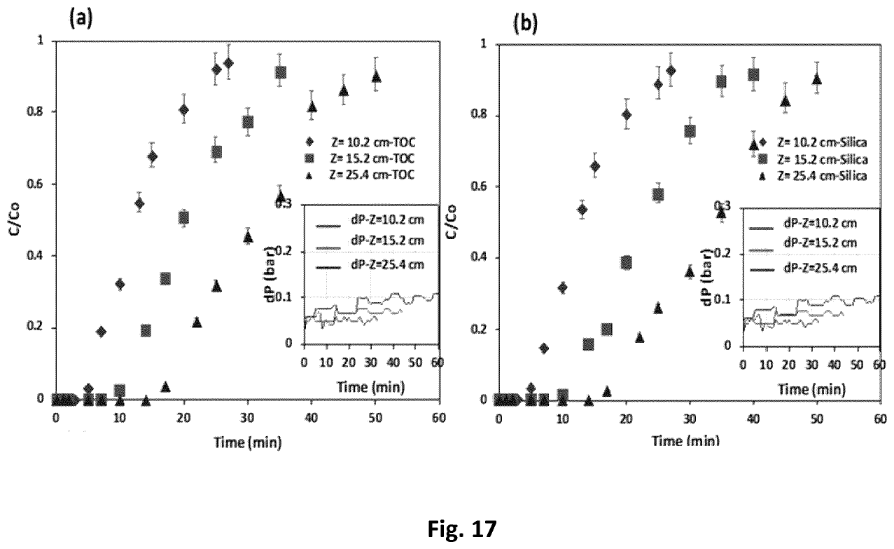

Effect of bed height—To study the effect of the length of the bed on the removal performance and breakthrough behavior, fixed-bed experiments were conducted at different lengths (10.2,15.2, and 25.4 cm), with unchanged feed concentration of silica (155 mg/L) and TOC (450 mg/L), and flow rate (10 mL/L). The experimental BTCs at these conditions are shown in FIG. 17. FIG. 17a illustrates the experimental BTCs of the TOC, while the experimental BTCs of silica are shown in FIG. 17b. As shown, when the column length increases, the number of binding sites tends to be higher. In such case, the TOC and silica molecules have more time to diffuse through the pores of the WS-NPs. These results indicate that they have a similar axial dispersion coefficient. It is also notable that by increasing the bed height, the increment in the pressure drop profile was limited and insignificant.

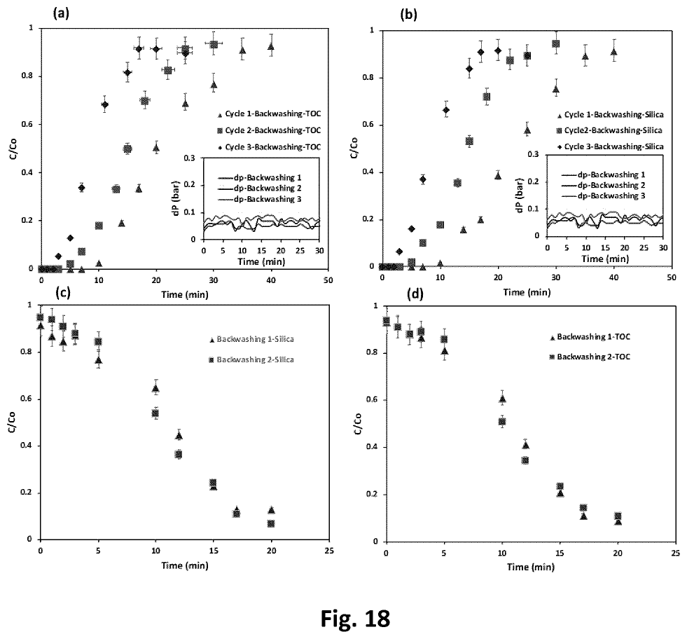

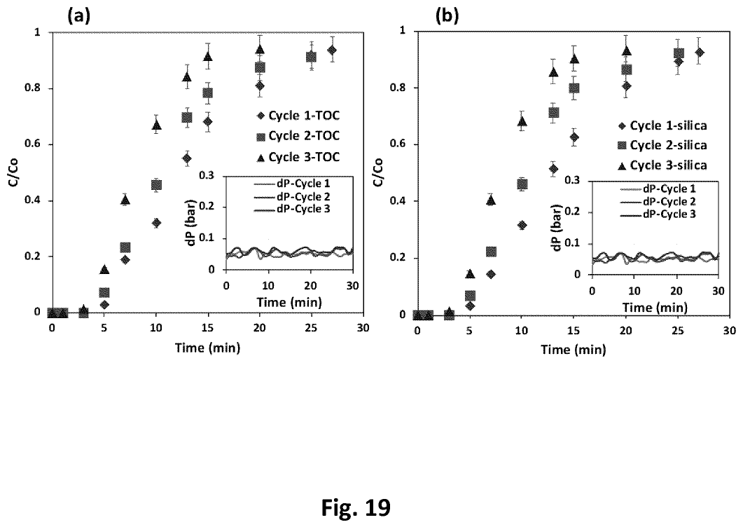

Regeneration and recyclability—FIG. 18 indicates the recyclability of the spent WS-NPs (Q=10 mL/min, C_{o,TOC}=450, C_{o,Silica}=1 55, and Z=10.6 cm that was obtained from the direct backwashing process. The figure includes sorption BTCs of TOC (FIG. 18a) and silica (FIG. 18b) along with the pressure drop profiles that resulted from direct backwashing of the spent column with diluted NaOH (0.1 mM) at 30 mL/min. The figure also presents the desorption profiles of TOC (FIG. 18c) and silica (FIG. 18d) that were achieved through backwashing the spent column. FIG. 18a,b clearly shows that the sorption breakthrough time and removal efficiency of the spent material are significantly reduced, while the pressure drop increased during every backwashing cycle. Also, longer backwashing time was obtained, indicating the consumption of huge amounts of backwashing solution. Thus, incomplete desorption of TOC and silica were obtained by applying a direct backwashing method, due to formation of an agglomerated oil layer that needs a high shear mixing or fluidization to be effectively removed. For that reason, the blade stirring method was alternatively applied to regenerate the spent WS-NPs. FIG. 19 shows the recyclability of the spent columns of WS-NP that was obtained at hydrodynamic conditions of Q=10 mL/min, C_{o,TOC}=450, C_{o,Silica}=155, and Z=10.6 cm. The figure includes the experimental BTCs and pressure drop profile of silica (FIG. 19a) and TOC (FIG. 19b) obtained through the regeneration of the spent WS-NPs. As illustrated from FIGS. 19a and 19b, a successful regeneration occurred through three regeneration cycles, such that there was a very limited reduction in the breakthrough time and removal efficiency of recycled WS-NPs. Table 7 shows the values of t_{b} and regeneration efficiency (% Regeneration) that is calculated as follows:

$$\% Regeneration = \frac{{q}_{cycle}}{{q}_{original}} \times 100 \% \qquad ( Equation 4 )$$

As confirmed from the data of Table 7, the regeneration efficiency was successfully implemented for the WS-NPs, and the regeneration efficiency was slightly influenced. In fact, each cycle was repeated by nearly complete removal of silica and TOC for three more subsequent cycles with capture efficiencies of 100, 91.5, and 81% for the subsequent cycles, proving that the characteristic of the WS-NPs was almost preserved. This indicated for attaining minor or insignificant leaching with respect to the material's performance as sorbent for both TOC and silica. The figure also confirms that the pressure drop profile was insignificantly impacted in every cycle. Interestingly enough, these obtained results can be considered strong evidence for the replacement of the employed material with our modified material without impacting the operating efficiency of the process, but significantly improving its removal capacity.

TABLE 7
Values of t_{b} and regeneration efficiency (%
Regeneration) calculated from Equation 4

| Cycle | t_{b} | t_{b} | % Regeneration | % Regeneration |
|---|---|---|---|---|
| number | (TOC) | (silica) | (TOC) | (silica) |
| 1 | 6 | 5 | 100 | 100 |
| 2 | 4 | 3.5 | 92.4 | 91.5 |
| 3 | 3.5 | 3 | 85.4 | 84.2 |

### Conclusions

With sustained lower oil prices and increased attention to environmental issues, there has been a growing need to improve water treatment efficiencies and cost. It is a good time to reflect on the technology used in the SAGD water treatment process, as existing plants are seeking to improve operating costs and uptime. In some SAGD sites, a precipitation softening process is involved through a warm lime softening (WLS) for silica removal, followed by filtration using a walnut shell filter (WSF), and weak acid cation exchange (WAC) to remove the carbonated and non-carbonated hardness. These technologies primarily focus on water recycling at high capital and operating costs, and very few of them showed effective remediation of silica and TOC with a lower environmental footprint. The technology presented herein modifies the surface of nutshell filter particles by anchoring iron(hydroxide) nanomaterials to the surface at various hydrolysis conditions (time, temperature, and concentration of iron precursor). The particles are fully characterized and tested to confirm their capacity for removal of the total organic carbon and silica in batch and fixed-bed column operations. Compared to the virgin particles, the walnut shell particles, in the presence of the nanomaterials at low mass percentage, have significant capacity to remove TOC and silica. In the batch experiments, the modified material performed well in removing up to 85% of silica and TOC compared with the non-modified nutshell filter particles that showed <5% removal efficiency. While in the fixed-bed column experiments, and similar to the industrial operation, the filter particle in presence of active nanomaterials, improved the breakthrough behavior, without having channeling or pressure drop limitations. Regeneration and recyclability of the spent column were successfully implemented through three successful cycles following direct backwashing and blade stirring methods. Similar efficiency of cleaning up of silica and TOC using conventional processes, has not been achieved. In fact, this outstanding efficiency can be reached with a simpler process: a single hybrid unit can outperform three existing units (WLS, WAC, and WSF) in the recycling of produced water generated from SAGD process. This unit can be simply implemented with minor modifications to the existing units, which would reduce the capital and operational costs. In summary, the innovative process described herein provides an outstanding “hybrid WSF unit” that would be transformative to many oil industries.

### Equivalents and Scope

Other than described herein, or unless otherwise expressly specified, all of the numerical ranges, amounts, values and percentages, such as those for amounts of materials, elemental contents, times and temperatures, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art.

It will be understood by those skilled in the art that various changes in form and details may be made to the embodiments described therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect +/− 10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

### REFERENCES

(1) Ji, D. et al. Analysis of steam—solvent—bitumen phase behavior and solvent mass transfer for improving the performance of the ES-SAGD process. J. Petroleum Sci & Eng. 2015, 133, 826-837.

(2) Liang G. et al. A new optimization method for steam-liquid level intelligent control model in oil sands steam-assisted gravity drainage (SAGD) process. Petroleum Exp. Dev. 2016, 43(2), 301-307.

(3) Dong, X. et al. Performance of multiple thermal fluids assisted gravity drainage process in post SAGD reservoirs. J. Petroleum. Sci. Eng. 2017, 154, 528-536.

(4) S. F. Abdelwahab, N. A., Shukry, N., & El-kalyoubi, Separation of emulsified oil from wastewater using polystyrene and surfactant modified sugarcane bagasse wastes blend., Clean Technol. Environ. Policy. (2020) 1-15. doi:10.1016/j.seppur.2008.06.002.

(5) Kar, T. et al. The Effect of Clay Type on Steam-Assisted-Gravity-Drainage Performance. J. Can. Petroleum Tech. 2015, 54(6), 412-423.

(6) Petersen, M. A., Grade, H. Analysis of Steam Assisted Gravity Drainage Produced Water using Two-Dimensional Gas Chromatography with Time-of-Flight Mass Spectrometry. Ind. Eng. Chem. Res. 2011, 50, 12217-12224.

(7) Zhou, Y-B. et al. Emulsified oily wastewater treatment using a hybrid-modified resin and activated carbon system. Sep. Purif. Technol. 2008, 63(2), 400-406.

(8) Yan, L.; Hong, S.; Li, M.; Shui, Y. Application of the Al₂O₃—PVDF nanocomposite tubular ultrafiltration (UF) membrane for oily wastewater treatment and its antifouling research. Sep. Purif. Technol. 2009, 66, 347-352.

(9) Heins, W. et al. Achieving Zero Liquid Discharge in SAGD Heavy Oil Recovery. J. Can. Petroleum Tech. 2004, 43(8), 37-42.

(10) Sankovich, M. F., McDonald, B. N. Once-Through Steam Generation. XVI Nuclear Congress, Rome, Italy, Mar. 25, 1971.

(11) Hajinasiri, J. Treatment of steam assisted gravity drainage produced water using polymeric membranes, University of Alberta Thesis, 2015.

(12) Bridle, M. Treatment of SAGD Produced Waters Without Lime Softening. SPE International Thermal Operations and Heavy Oil Symposium, Calgary, Nov. 1, 2005.

(13) Pedenaud, P. et al. Oily-Water Treatment Schemes for Steam Generation in SAGD Heavy-Oil Developments. SPE International Thermal Operations and Heavy Oil Symposium, Calgary, Nov. 1, 2005.

(14) Kawaguchi, H. et al. Dissolved organic compounds in reused process water for steam-assisted gravity drainage oil sands extraction. Water Res. 2012, 46(17), 5566-5574.

(15) Allen, E. W. Process water treatment in Canada's oil sands industry: I. Target pollutants and treatment objectives. J. Environ. Eng. Sci. 2008, 7(2), 123-138.

(16) Igunnu, E. T.; Chen, G. Z. Produced water treatment technologies. Int. J. Low-Carbon Tech. 2014, 9(3), 157-177.

(17) Elsayed, N. A. et al. An integrated approach for incorporating thermal membrane distillation in treating water in heavy oil recovery using SAGD. J. Unconventional Oil & Gas Resources 2015, 12, 6-14.

(18) Ku, A. Y. et al. Aging of Water from Steam-Assisted Gravity Drainage (SAGD) Operations Due to Air Exposure and Effects on Ceramic Membrane Filtration. Ind. Eng. Chem. Res. 2012, 51, 7170-7126.

(19) Munirasu, S. et al. Use of membrane technology for oil field and refinery produced water treatment—A review. Process Safety & Envir. Prot. 2016, 100, 183-202.

(20) Campos, J. C. et al. Oilfield wastewater treatment by combined microfiltration and biological processes. Water Res. 2002, 36(1), 95-104.

(21) Zhong, J. et al. Treatment of oily wastewater produced from refinery processes using flocculation and ceramic membrane filtration. Sep. Purif. Tech. 2003, 32(1-3), 93-98.

(22) Tsuno, H., Zainol, N. Nitrogen nutrient removals from wastewater and river water. Water Sci. Technol. 2018, 45, 197-204.

(23) Rawlins, C. H.; et al. Experimental Study on Oil Removal in Nutshell Filters for Produced-Water Treatment. SPE Prod. Oper. 2018, 33, 145-153.

(24) Rawlins, C. H. Experimental study on oil and solids removal in nutshell filters for produced water treatment. SPE Western Regional Meeting, Garden Grove, Calif., USA, Apr. 22, 2018.

(25) A. L. S. Liu, Study on performance of three backwashing modes of filtration media for oilfield wastewater filter, Desalin. Water Treat. 57 (2015) 10498-10505.

(26) G. Crittenden, J., Trusell, R., Hand, D., Howe, K., & Techobanoglous, Water Treatment: Principles and Design, 2005, pp. 674-678.

(27) R. M. Cornell, U. Schwertmann, The Iron Oxides: Structure, Properties, Reactions, Occurences and Uses, 2nd ed., Copyright © 2003 Wiley-VCH Verlag GmbH & Co. KGaA, 2003. doi:10.1002/3527602097, pp 203-207.

(28) J. R. Nieto-Delgado, C., & Rangel-Mendez, Anchorage of iron hydro (oxide) nanoparticles onto activated carbon to remove As (V) from water, Water Res. 46 (2012) 2973-2982.

(29) X. Zhu, L. Yiming, H. Yang, Z. Yangge, S. Changxing, W. Weiqing, Adsorption of ferric ions on the surface of bastnaesite and its significance in flotation, Miner. Eng. 158 (2020) 106588.

(30) J. Zhao, Z. Lu, X. He, X. Zhang, Q. Li, T. Xia, W. Zhang, C. Lu, Y. Deng, One-Step Fabrication of Fe(OH)3@Cellulose Hollow Nanofibers with Superior Capability for Water Purification, ACS Appl. Mater. Interfaces. 9 (2017) 25339-25349. doi: 10. 1021/acsami.7b07038.

(31) van den Heuvel, D. B., Gunnlaugsson, E., Gunnarsson, I., Stawski, T. M., Peacock, C. L., & Benning, L. G. (2018). Understanding amorphous silica scaling under well-constrained conditions inside geothermal pipelines. Geothermics, 76, 231-241.

(32) Alexander, G. B. et al. The solubility of amorphous silica in water. J. Phys. Chem. 1954, 58 (6), 453-455.

(33) Manceau, A. et al. Crystal chemistry of hydrous iron silicate scale deposits at the Salton Sea geothermal field. Clays Clay Miner. 1995, 43(3), 304-317.

(34) Luo, M., & Wang, Z. Complex fouling and cleaning-in-place of a reverse osmosis desalination system. Desalination 2001, 141(1), 15-22.

(35) Al-As'ad, A. Treatment of SAGD water using low coagulant dose and Fenton oxidation, University of Calgary, 2013.

(36) U.S. Patent Application No. US20150192003.

1. A filter medium for removal of contaminants from wastewater, the filter medium comprising: a nut shell particle having a metal hydro(oxide) nanoparticle bonded to a surface thereof.

2. The filter medium of claim 1, wherein the metal is a transition metal or a Group IIIA metal.

3. The filter medium of claim 2, wherein the metal is iron or aluminum or a mixture thereof.

4. The filter medium of claim 1, wherein the nut shell is a walnut shell or a pecan shell.

5. The filter medium of claim 1, wherein the nanoparticle is bonded to the surface of the nut shell particle via an oxygen bridge.

6. A process for preparing a filter medium for removal of contaminants from wastewater, the process comprising:
treating a nut shell filter medium with an aqueous acid solution and washing the nut shell filter medium;
mixing the nut shell filter medium with a source of metal ions, to generate a mixture including an aqueous metal complex and heating the mixture to promote a thermal hydrolysis reaction which generates a metal hydro(oxide) nanoparticle bonded to a surface of the nut shell medium.

7. The process of claim 6, wherein the metal is a transition metal or a Group IIIA metal.

8. The process of claim 7, wherein the metal is iron or aluminum or a mixture thereof.

9. The process of claim 6, wherein the nut shell is a walnut shell or a pecan shell.

10. The process of any one of claim 6, wherein the nanoparticle is bonded to the surface of the nut shell particle via an oxygen bridge.

11. A process for treating wastewater to remove contaminants, the process comprising:
Contacting the wastewater with a nut shell particle as recited in claim 1, such that the contaminants adhere to the metal hydro(oxide) nanoparticle and recovering water having at least some of the contaminants removed therefrom.

12. The process of claim 11, wherein the step of contacting the wastewater with the nut-shell particle is performed in a batch mode.

13. The process of claim 11, wherein the contaminants include total organic carbon (TOC).

14. The process of claim 11, wherein the contaminants include silica and silicates.

15. A process for treatment of wastewater in a steam-assisted gravity drainage (SAGD) operation, the process comprising filtering the wastewater with the filter medium of claim.
